(19) United States
(12) Patent Application Publication
(10) Pub. No.: US 2016/0170791 A1
(43) Pub. Date: Jun. 16, 2016

(54) DEVICE FOR CONTROLLING MIGRATION IN A DISTRIBUTED CLOUD ENVIRONMENT AND METHOD FOR CONTROLLING MIGRATION USING THE SAME

(71) Applicant: UNIVERSITY-INDUSTRY COOPERATION GROUP OF KYUNG HEE UNIVERSITY, Yongin (KR)

(72) Inventors: Eui-Nam Huh, Yongin (KR); A-Young Son, Yongin (KR)

(21) Appl. No.: 14/957,693

(22) Filed: Dec. 3, 2015

(30) Foreign Application Priority Data
Dec. 10, 2014 (KR) 10-2014-0177839

(51) Int. Cl. G06F 9/455; G06F 9/50

(52) U.S. Cl. CPC G06F 9/45558; G06F 9/5077; G06F 2009/4557; G06F 2009/45595

(57) ABSTRACT

The present invention provides a migration control method in a distributed cloud environment in which a migration control device controls migration of a virtual machine to allocate a resource in a distributed cloud environment including: measuring and monitoring a resource usage amount of virtual machines of a data center in the unit of time; detecting a hotspot in which the measured resource usage amount exceeds a predetermined threshold value and selecting a target virtual machine to be migrated in a server which is detected as the hotspot, and performing migration of the virtual machine from the server which is detected as the hotspot to a server to which the virtual machine will be moved in consideration of the resource usage rate of the target virtual machine.

### CROSS-REFERENCE TO RELATED APPLICATION

This application claims priority to and the benefit of Korean Patent Application No. 10-2014-0177839 filed in the Korean Intellectual Property Office on Dec. 10, 2015, the entire contents of which are incorporated herein by reference.

### BACKGROUND OF THE INVENTION

(a) Field of the Invention

The present invention relates to a migration control device in a distributed cloud environment and a migration control method using the same.

(b) Description of the Related Art

Recently, it is a trend to globally increase a customer demand on a cloud service. In order to correspond to the increasing client demand, cloud service providers build data centers in large areas to increase the size of the systems. However, a resource load in a cloud environment where data centers which are regionally distributed are operated largely affects a response speed.

Further, according to studies of the related art, even though overall migration time is decreased, overhead is still generated and the overall migration time is slow. In addition, according to the related art, service waiting time is generated, but the service waiting time is not considered. Therefore, when the load of the entire system is large, it is difficult to precisely predict a performance of an application program and dynamically allocate the resource.

Further, since the current data centers are not single data centers, but are in a cloud environment where the data centers are distributed, a technique which can provide a seamless service when a user moves to another region in the distributed cloud environment is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a migration control device which continuously provides an existing service even when a user moves to another region in a distributed cloud environment and a migration control method using the same.

An exemplary embodiment of the present invention provides a migration control method in a distributed cloud environment in which a migration control device controls migration of a virtual machine to allocate a resource in a distributed cloud environment, the method including: measuring and monitoring a resource usage amount of virtual machines of a data center in the unit of time; detecting a hotspot in which the measured resource usage amount exceeds a predetermined threshold value and selecting a target virtual machine to be migrated in a server which is detected as a hotspot; and performing migration of the virtual machine from the server which is detected as the hotspot to a server to which the virtual machine will be moved in consideration of the resource usage rate of the target virtual machine.

The monitoring may include measuring a CPU usage and a memory usage for the virtual machines and predicting a service execution time. The selecting of a target virtual machine may include determining a virtual machine and a resource which become a cause of the hotspot in consideration of the service execution time and the resource usage amount of the virtual machines in the server which is detected as the hotspot.

The service execution time may include a waiting prediction time and the waiting prediction time may be deduced using a service usage rate in accordance with a service usage rate or a service arrival rate which is calculated in accordance with Poisson distribution or exponential distribution. The performing of migration may include comparing resource usage rates of the virtual machines and assigning a priority to a virtual machine having a high resource usage rate.

Another exemplary embodiment of the present invention provides a migration control device in a distributed cloud environment including: a monitoring unit which measures and monitors a resource usage amount of virtual machines in the unit of time in a distributed cloud environment; a selecting unit which detects a hotspot using the resource usage amount and selects a target virtual machine to be migrated in the server which is detected as the hotspot; and a control unit which migrates the virtual machine from the server which is detected as the hotspot to a server to which the virtual machine will be moved in consideration of the resource usage rate of the target virtual machine.

he selecting unit may include a hotspot detecting unit which compares the monitored resource usage amount with a predetermined threshold value and detects a server whose resource usage amount exceeds the threshold value as a hotspot and a virtual machine determining unit which determines a virtual machine or a resource which is a cause of the hotspot in consideration of a service execution time and the resource usage amount of the virtual machines in the server which is detected as the hotspot. The control unit may assign a priority to a virtual machine having a high resource usage rate among virtual machines to be migrated and control the virtual machine having a high priority to be preferentially migrated.

According to the present invention, the target virtual machine is determined in complexly considering the waiting time or executing time and a resource status in a distributed cloud environment to provide an environment where QoS is secured and performance is improved while minimizing a waiting time for migration, thereby increasing efficiency.

### BRIEF DESCRIPTION OF THE DRAWINGS

FIG. 1 is a view schematically illustrating a structure of a migration control device according to an exemplary embodiment of the present invention.

FIG. 2 is a flowchart schematically illustrating a process of determining a target virtual machine to perform migration by a migration control device according to an exemplary embodiment of the present invention.

FIG. 3 is a view of an example of migration in a distributed cloud environment according to an exemplary embodiment of the present invention.

FIG. 4 is a view which compares migration times of the related art and an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In the specification, unless explicitly described to the contrary, the word “comprise” and variations such as “comprises” or “comprising”, will be understood to imply the inclusion of stated elements but not the exclusion of any other elements.

In addition, the terms “-er” and “module” described in the specification mean units for processing at least one function and operation and can be implemented by hardware components or software components and combinations thereof.

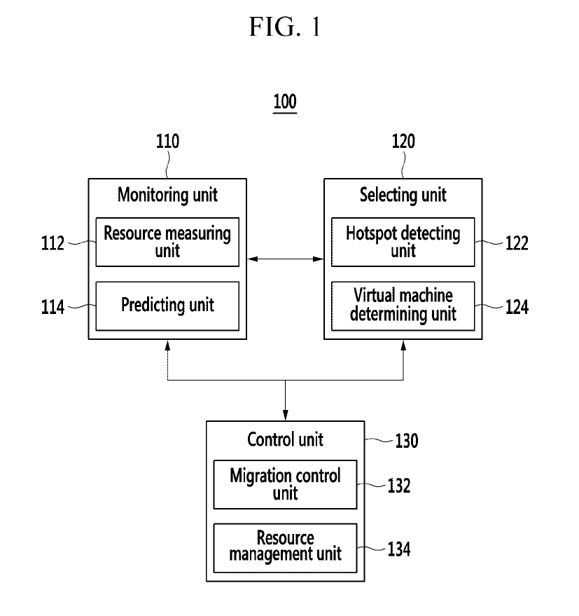

Now, a migration control device in a distributed cloud environment according to an exemplary embodiment of the present invention and a migration control method using the same will be described in detail with reference to FIGS. 1 to 4.

FIG. 1 is a view schematically illustrating a structure of a migration control device according to an exemplary embodiment of the present invention. In this case, only a schematic configuration of the migration control device which is required to describe an exemplary embodiment of the present invention will be illustrated, but the present invention is not limited to the configuration.

Referring to FIG. 1, a migration control device according to an exemplary embodiment of the present invention selects a target in complexly considering a waiting time and a status of a resource in a distributed cloud environment and performs migration. Even though a user who receives a service from a specific micro data center in a distributed cloud environment moves to another region, the migration control device according to an exemplary embodiment of the present invention may continuously provide an existing service from a new micro data center which is geographically close to the specific micro data center.

The migration control device 100 according to an exemplary embodiment of the present invention includes a monitoring unit 110, a selecting unit 120, and a control unit 130.

The monitoring unit 110 measures and monitors a resource usage amount of virtual machines (VM) in a distributed cloud environment. The monitoring unit 110 may measure a CPU usage and a memory usage in the unit of time through a graphite monitoring tool according to the exemplary embodiment of the present invention.

The monitoring unit 110 includes a resource measuring unit 112 and a usage predicting unit 114 according to the exemplary embodiment of the present invention.

The resource measuring unit 112 measures a resource usage amount such as the CPU usage and the memory usage for the virtual machines. Further, the predicting unit 114 predicts a service execution time or a waiting time by the virtual machines.

The selecting unit 120 detects a hotspot using a resource usage amount measured by the monitoring unit 110 and selects a target virtual machine on which migration is performed in the server which is detected as the hotspot. Here, the selecting unit 120 detects the hotspot to determine whether to perform the migration and determines a target virtual machine in accordance with the waiting time and a necessary resource amount.

The selecting unit 120 includes a hotspot detecting unit 122 and a virtual machine determining unit 124 according to an exemplary embodiment of the present invention.

The hotspot detecting unit 122 compares the monitored resource usage amount with a predetermined threshold value and detects a server whose resource usage amount exceeds the threshold value as a hotspot.

The virtual machine determining unit 124 determines a virtual machine or a resource which becomes a cause of the hotspot in consideration of the service execution time and the resource usage amount of the virtual machines in a server which is detected as a hotspot in the hot spot detecting unit 122.

The control unit 130 controls to migrate the virtual machine from the server which is detected as a hotspot to a server to which the virtual machine will be moved in consideration of the resource usage rate of the target virtual machine. The control unit 130 assigns a priority to a virtual machine having the high resource usage rate among virtual machines to be migrated and controls to preferentially migrate the virtual machine having a higher priority.

The control unit 130 includes a migration control unit 132 and a resource management unit 134 according to the exemplary embodiment of the present invention.

The migration control unit 132 determines a server to migrate a virtual machine and controls the server to select a virtual machine to be migrated.

The resource management unit 134 assigns a priority to a virtual machine having a high resource usage rate among virtual machines to be migrated and manages the resource so as to preferentially migrate the virtual machine having a higher priority.

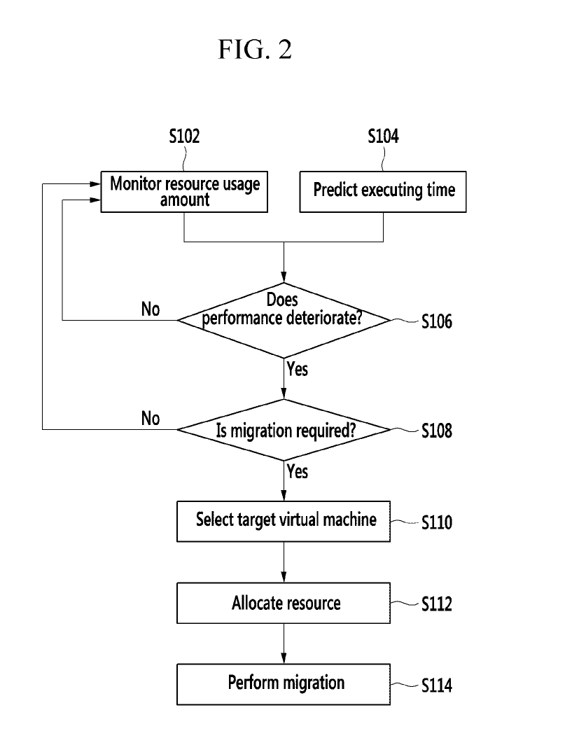

FIG. 2 is a flowchart schematically illustrating a process of determining a target virtual machine to perform migration by a migration control device according to an exemplary embodiment of the present invention. In the following flowchart, same reference numerals as those of the configuration of FIG. 1 will be used.

Referring to FIG. 2, according to an exemplary embodiment of the present invention, the migration control device 100 measures a resource of the virtual machine in the micro data centers (MDC) in the distributed cloud environment and monitors a resource usage amount such as a CPU usage and a memory usage in step S102.

Further, the migration control device 100 predicts a service execution time of the virtual machines in step S104.

Further, the migration control device 100 determines whether a performance of the micro data center or the virtual machines deteriorates based on the resource usage amount and the service execution time and determines whether the migration is required based on the resource usage amount and the service execution time in steps S106 and S108.

When it is determined that the migration is required, the migration control device 100 selects a micro data center or a target virtual machine which performs the migration in step S110. Here, the migration control device 100 detects a hotspot in which a measured resource usage amount exceeds a predetermined threshold value to select a micro data center to migrate a virtual machine and selects a target virtual machine to be migrated in the micro data center.

The migration control device 100 allocates a resource in consideration of a resource usage rate of the target virtual machine and controls the target virtual machine to be migrated from a server of the micro data center which is detected as a hotspot to a server to which the virtual machine will be moved in steps S112 and S114.

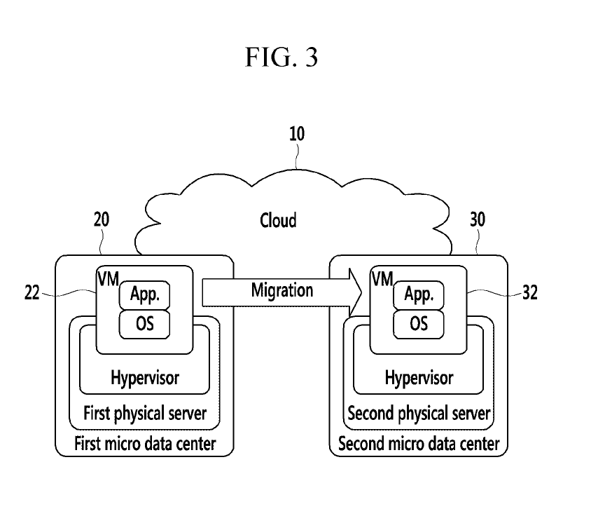

FIG. 3 is a view of an example of migration in a distributed cloud environment according to an exemplary embodiment of the present invention.

As illustrated in FIG. 3, according to an exemplary embodiment of the present invention, even when a user which receives a service from a first micro data center 20 in a distributed cloud environment moves to another region, the migration control device 100 deducts a method which allows the user to continuously receive the same service from a second micro data center 30 which is geographically close to the first micro data center and efficiently use a resource which is an issue in the cloud environment.

Hereinafter, a migration process which is performed by the migration control device 100 in complexly considering the time and the resource, according to an exemplary embodiment of the present invention will be described in detail.

The migration control device 100 monitors a resource usage amount of the virtual machines and predicts a service execution time of the virtual machines as a prior step for migration.

The migration control device 100 monitors a resource in the micro data center and measures resources of the virtual machines in the micro data center. The migration control device 100 measures a consumed resource amount of a virtual machine to be migrated and resources of other virtual machines.

The migration control device 100 predicts a service execution time through the following Equation 1.

W=Wq+E[ST]

W=Wq+E[ST] (Equation 1)

Here, W indicates a service execution time, Wq is a waiting prediction time, and E[ST] indicates a service execution time. As represented in Equation 1, the migration control device 100 adds the waiting prediction time and the service execution time to deduce the service execution time W.

Further, the migration control device 100 determines whether the migration needs to be performed in consideration of the monitored resource usage amount and service execution time and determines whether to perform migration.

Further, the migration control device 100 selects the target machine using the following Equation 2 and Equation 3.

$$min \frac{1}{γ ( γ - 1 )} \\ s . t P ( n ) \leq {Th}_{r} \\ min \frac{1}{γ ( γ - 1 )} \\ s . t P ( n ) \leq {Th}_{r} \qquad ( Equation 2 )$$

Here, γ indicates a possibility of waiting service, P(n) indicates a waiting possibility, and Thr indicates a threshold value of prediction possibility.

As represented in Equation 2, the migration control device 100 calculates a service rate and a service arrival rate in accordance with Poisson distribution and exponential distribution and predicts a waiting prediction time using the service usage rate in accordance with the service arrival rate.

Further, the migration control device 100 may calculate the number of waiting virtual machines in accordance with the waiting time through the following Equation 3.

$${V}_{q} = \frac{{\int }_{{t}_{0}}^{{t}_{q}} q ( t ) d t}{{t}_{n} - {t}_{0}} \\ {V}_{q} = \frac{{\int }_{{t}_{0}}^{{t}_{q}} q ( t ) d t}{{t}_{n} - {t}_{0}} \qquad ( Equation 3 )$$

Here, t indicates a waiting time and Vq indicates the number of waiting virtual machines.

The migration control device 100 calculates the number of waiting virtual machines using Equation 3. Further, the migration control device 100 may select a server in the micro data center whose waiting time is below an average using the average waiting time of the servers obtained using Equation 3.

The migration control device 100 performs the migration using the following Equation 4.

$${P}_{resource} = \frac{E [ T ] + E [ ST ]}{E [ ST ]} \qquad ( Equation 4 )$$

Here, P_{resource} indicates a priority of a resource, E[T] indicates a waiting time, and E[S] indicates a service execution time.

The migration control device 100 assigns the top priority to a resource and compares the resource usage rate of the virtual machine which will be migrated in real time to assign high priority to a resource or a virtual machine having a high usage rate.

As described above, when the hotspot is detected or predicted, the migration control device 100 determines which virtual machine or resource becomes a cause of the hotspot based on the resource usage rate of the virtual machines of the server and determines a migration target in real time therethrough.

In this case, the resource usage rate of the virtual machine which will be moved in real time becomes a requirement which is required by the server to be moved and the top priority is assigned to the resource which is a cause of the hotspot to assign a priority to a resource having a high resource usage rate of the virtual machine which will be migrated in real time in the descending order.

The migration control device 100 compares every resource in the descending order of priority and searches a server to which the virtual machine will be moved in real time which satisfies a requirement of a source virtual machine to perform migration.

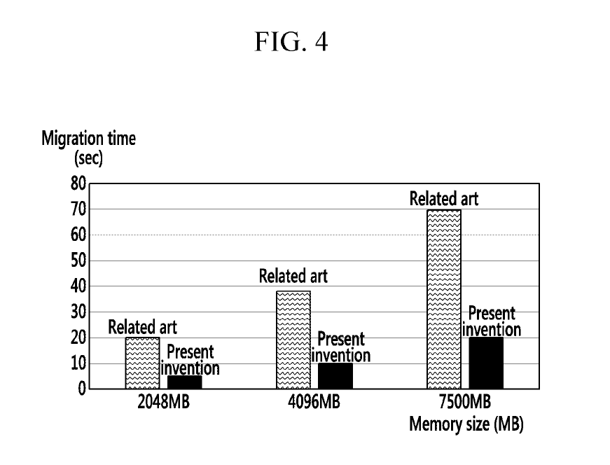

FIG. 4 is a view which compares migration times of the related art and an exemplary embodiment of the present invention.

Referring to FIG. 4, it is confirmed that a migration time by a memory through the migration control device 100 according to the exemplary embodiment of the present invention is 75% or more improved as compared with the migration time of the related art. When the migration is performed in the server, a waiting time may occur in the virtual machines in accordance with resource shortage and a variable status of the service.

As illustrated in FIG. 4, the migration performed in consideration of the waiting time and the resource may improve the performance of the virtual machines and determine the target virtual machine, which may reduce cost for the resource.

As described above, the migration control device according to the exemplary embodiment of the present invention determines a target virtual machine in complexly considering the waiting time or execution time and a resource status in the distributed cloud environment to provide an environment where QoS is secured and performance is improved while minimizing waiting time for migration, thereby increasing efficiency.

The above described exemplary embodiment of the present invention is implemented not only through the device and the method, but also through a program which executes a function corresponding to a configuration of an exemplary embodiment of the present invention or a recording medium in which the program is recorded. Such a recording medium may be executed not only in the server, but also in the user terminal.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A migration control method in a distributed cloud environment in which a migration control device controls migration of a virtual machine to allocate a resource in a distributed cloud environment, the method comprising:
measuring and monitoring a resource usage amount of virtual machines of a data center in the unit of time;
detecting a hotspot in which the measured resource usage amount exceeds a predetermined threshold value and selecting a target virtual machine to be migrated in a server which is detected as the hotspot; and
performing migration of the virtual machine from the server which is detected as the hotspot to a server to which the virtual machine will be moved in consideration of a resource usage rate of the target virtual machine.

2. The migration control method of claim 1, wherein the monitoring includes
measuring a CPU usage and a memory usage for the virtual machines and predicting a service execution time.

3. The migration control method of claim 2, wherein the selecting of a target virtual machine includes
determining a virtual machine and a resource which become a cause of the hotspot in consideration of the service execution time and the resource usage amount of the virtual machines in the server which is detected as the hotspot.

4. The migration control method of claim 3, wherein the service execution time includes a waiting prediction time and
the waiting prediction time is deduced using a service usage rate in accordance with a service rate or a service arrival rate which is calculated in accordance with Poisson distribution or exponential distribution.

5. The migration control method of claim 4, wherein the performing of migration includes
comparing resource usage rates of the virtual machines and assigning a priority to a virtual machine having a high resource usage rate.

6. A migration control device in a distributed cloud environment, the device comprising:
a measuring unit which measures and monitors a resource usage amount of virtual machines in the unit of time in a distributed cloud environment;
a selecting unit which detects a hotspot using the resource usage amount and selects a target virtual machine to be migrated in the server which is detected as the hot spot; and
a control unit which migrates the virtual machine from the server which is detected as a hotspot to a server to which the virtual machine will be moved in consideration of a resource usage rate of the target virtual machine.

7. The migration control device of claim 6, wherein the selecting unit includes:
a hotspot detecting unit which compares the monitored resource usage amount with a predetermined threshold value and detects a server whose resource usage amount exceeds the threshold value as a hotspot; and
a virtual machine determining unit which determines a virtual machine or a resource which is a cause of the hotspot in consideration of a service execution time and the resource usage amount of the virtual machines in the server which is detected as the hotspot.

8. The migration control device of claim 7, wherein the control unit assigns a priority to a virtual machine having a high resource usage rate among virtual machines to be migrated and controls the virtual machine having a high priority to be preferentially migrated.
